(19) United States
(12) Patent Application Publication
(10) Pub. No.: US 2003/0012346 A1
(43) Pub. Date: Jan. 16, 2003

(54) System and method for recording telephone conversations

(76) Inventors: Christopher Langhart, New Hope, PA (US); Robert E. Hankey, Wayne, PA (US)

Correspondence Address: KENYON & KENYON, Suite 600, 333 W. San Carlos St., San Jose, CA, 95110, US

(21) Appl. No.: 10/187,009

(22) Filed: Jun. 28, 2002

Related U.S. Application Data
(62) Division of application No. 09/795,875, filed on Feb. 27, 2001.

(51) Int. Cl. H04M 1/64

(52) U.S. Cl. 379/67.1

(57) ABSTRACT

The present invention is directed to a system and method for recording telephone conversations. In one embodiment, a telephone conversation between two or more parties is recorded and the recording of the conversation can be stopped without terminating or effecting the communication between the parties. Any of the parties to the conversation may request that the conversation be recorded or terminate the recording of that conversation. The party initiating the recording of the conversation may request the playback of the recorded conversation provided that party has playback service. If one of the parties requests that the conversation be recorded, then the non-recording parties (i.e., the one or more parties not requesting that the conversation be recorded) are notified that the conversation is being recorded if the applicable law at the location of the non-recording parties mandates that the non-recording parties be notified that the conversation is being recorded.

### FIELD OF THE INVENTION

The present invention relates generally to communication systems and in particular, to a system and method for recording telephone conversations.

### BACKGROUND OF THE INVENTION

Communication systems, more particularly cellular phone systems, are often used where the subscriber unit is mobile or where the user of the subscriber unit is also engaged in a physical activity in addition to use of the subscriber unit. In such situations it is often necessary to remember an address or other detailed information which is mentioned in the conversation by one of the parties. Normally, a party requesting the information would write down that information by hand, however, if another conflicting/simultaneous activity is being conducted while the subscriber unit is in use (such as operating an automobile), then this recording method may not be feasible. Efforts at note writing while driving or walking are at best clumsy and may even be dangerous.

Present commercially available solutions for automating the note-taking task while concurrently performing another activity include the use of auxiliary outboard microphones which are associated with cassette style recorders such as those available from Thomas Investigative Publications of Austin Tex. The use of these devices results in obstacles, such as, the extra wires associated with the additional microphone may not be compatible with some physical activities concurrent with talking on the cell phone (e.g., the wires or having to activate the microphone for recording may interfere with driving a vehicle). Therefore, a mechanism is needed to easily record a conversation with minimal impact on concurrent physical activities.

Another commercially available solution for automating the note-taking task include the SCH-8500 mobile telephone from Samsung Electronics Company. The SCH-8500 includes a “memo recording feature” that, if there is no call in progress, records the speech only of the party who initiated the memo recording feature. If a call is in progress and the mobile telephone is in digital mode, the speech of only the called party is recorded and this speech can be recorded for a maximum of one minute. The memo recording feature is deficient, however, because it does not record the conversation between the parties (i.e., does not record concurrently the speech of all the parties to the conversation) and if a call is in progress, does not record the speech of the party who initiated the memo recording feature. Nor does the SCH-8500 allow a party to block recording. Such a feature would be desirable.

Some state laws deem illegal the recording of telephone conversations without the consent or knowledge of all or some of the parties to the conversation. In those States/locations where this is the case, if the non-recording party (i.e., the party not requesting that the conversation be recorded) is not informed that the conversation is being recorded, then the recording party violates the law by recording the conversation. The SCH-8500, does notify the non-recording party that the conversation is being recorded. Therefore, if the applicable law at the location of the non-recording party mandates, it is desirable to notify the non-recording party that the conversation is being recorded and allow the non-recording party to object and/or terminate the recording of the conversation.

At the present time, the typical mechanical solution to not being able to physically store portions of a telephone conversation is the note pad and if in a vehicle, the note pad with attached suction cup for adhering the note pad to the vehicle window or dashboard surface. However, if the user of the telephone forgets the note pad or a writing instrument, then details of the conversation cannot be physically recorded. In the case of writing while operating a vehicle, not having the use of both hands to operate the vehicle may increase the likelihood of an automobile accident especially in bad weather or bad roads. Therefore, a mechanism is needed to record conversations or portions thereof such that the mechanism for recording does not use external devices that may be inadvertently forgotten, or whose use may be distracting.

For the foregoing reasons, there is a need to include a conversation recording feature into the existing telephone facilities.

### SUMMARY OF THE INVENTION

A system and method are disclosed for recording a telephone conversation among parties. A first embodiment of a telephone system for recording a conversation is described that includes a conversation recording unit that records the conversation among a first party on a first telephone and a second party on a second telephone. The telephone system also includes an infrastructure unit that interconnects the first telephone and the second telephone. In this embodiment, the first telephone and the second telephone are a fixed telephone or a mobile telephone and the conversation recording unit is located within the infrastructure unit, the first telephone and the second telephone that is the mobile telephone, or an outside facility that is conferenced in to record the conversation.

An embodiment of a conversation recording unit is also described that includes a conversation storage unit that stores a conversation among a first party on a first telephone and a second party on a second telephone. The conversation recording unit also includes a processor, attached to the conversation storage unit, that directs the conversation to the conversation storage unit for storage upon receiving a control signal to record the conversation.

A first embodiment of a method for recording a conversation is also described that includes establishing a connection among a first telephone and a second telephone, and recording the conversation among a first party on the first telephone and a second party on the second telephone. In this embodiment, the first telephone and the second telephone are a fixed telephone or a mobile telephone and the recording occurs within the infrastructure unit, the first telephone and the second telephone that is the mobile telephone, or an outside facility that is conferenced in to record the conversation.

A first embodiment of a header of a recorded conversation is also described. The header includes a unique serial number; and the identities of: (1) a first telephone of a first party that initiated recording a conversation; (2) a second telephone of a second party that did not initiate recording the conversation; and (3) the parties that are allowed to playback the recorded conversation.

### BRIEF DESCRIPTION OF THE DRAWINGS

FIG. 1 shows a telephone system according to one embodiment of the present invention.

FIG. 2 shows a conversation recording unit according to one embodiment of the present invention.

FIG. 3 shows a flowchart describing a process for recording a telephone conversation during an ongoing conversation according to one embodiment of the present invention.

FIG. 4 shows a flowchart describing a process for playing back a recorded telephone conversation according to a first embodiment of the present invention.

FIG. 5 shows a flowchart describing a process for playing back a recorded telephone conversations according to a second embodiment of the present invention.

FIG. 6 shows a flowchart describing a process for playing back a recorded telephone conversation according to a third embodiment of the present invention.

### DESCRIPTION

One embodiment of the present invention provides a method and system for recording a telephone conversation between two or more parties and selectively terminating the recording of the conversation without terminating or effecting the communication between the parties. Any of the parties to the conversation may request that the conversation be recorded or terminate the recording of that conversation. The recording of the conversation may be started/stopped as many times as the parties desire. The party initiating the recording of the conversation may request the playback of the recorded conversation provided that party has playback service. The recordings may be reviewed in a manner similar to voice mail and the protections used in voice mail are used to ensure that only the appropriate party has access to the recorded conversation and can playback the recorded conversation. When a party desires to record a passage of the ongoing conversation, he or she can, for example, depress a predetermined button or button sequence to record the conversation. At the end of the passage to be recorded, another predetermined button or button sequence can be depressed to halt the recording process without affecting the ongoing conversation.

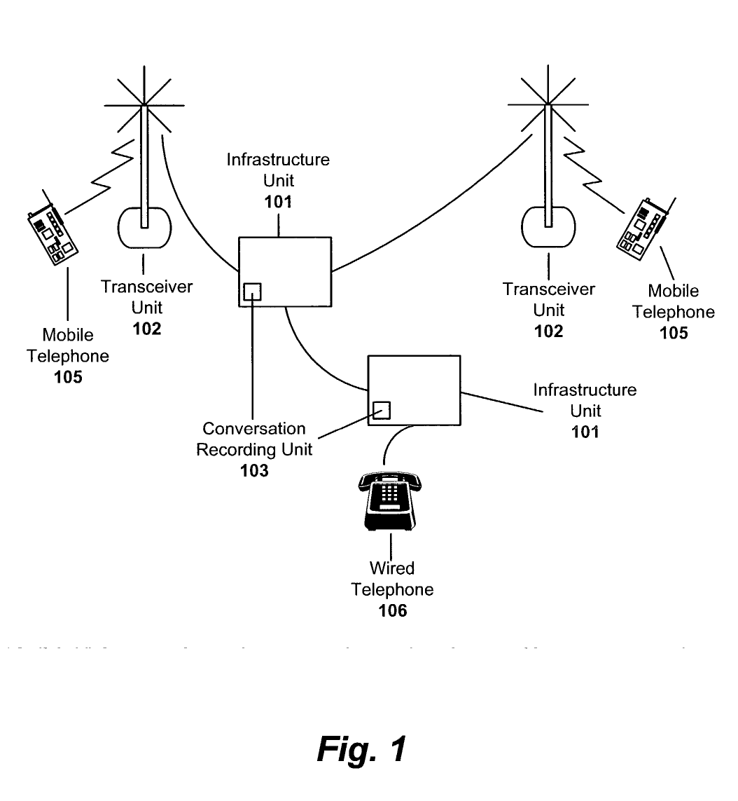

FIG. 1 shows a telephone system 100 according to one embodiment of the present invention. In this embodiment, an infrastructure unit 101 interconnects the telephones of an initiating party and a receiving party. Infrastructure unit 101 may be a mobile telephone switching office that is used to track and switch mobile telephones 105 as they move from one cell to another. Infrastructure unit 101 may also be a central office that is used to interconnect a conventional fixed telephone 106 to other fixed telephones or mobile telephones. Fixed telephone 106 has two or more copper wires coming out of it that may go to the central office which acts as a switching center where interconnections to other telephones occur. Mobile telephones 105 are wireless radiotelephones that allow a user to connect with another user. Conventional fixed telephone 106 uses copper wires to connect to the central office and thus connect to other telephones. Alternatives to the copper wires include fiber-optic and radio means. Transceiver units 102 wirelessly connect mobile telephones 105 to infrastructure unit 101. A conversation recording unit 103 records conversations between two or more parties and allows an appropriate party to playback the recorded conversation. Conversation recording unit 103 resides in infrastructure units 101. Alternatively or in addition, conversation recording unit 103 also resides in mobile telephone 105 or at an outside facility and is “conferenced in” from the outside facility when one of the parties requests that the conversation be recorded. The outside facility may not be part of telephone system 100 and may be operated by subcontractors and other entities that are not a telephone service provider.

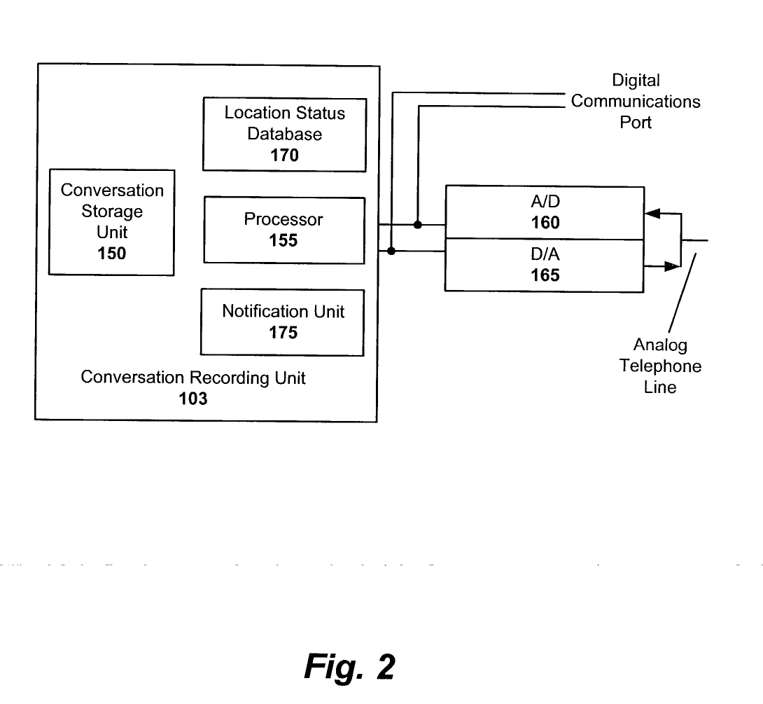

FIG. 2 shows conversation recording unit 103 in more detail. Conversation recording unit 103 includes a processor 155 that processes the information sent by the parties from their mobile telephones 105 or fixed telephone 106. Mobile telephone 105 and fixed telephone 106 provide control signals that are transmitted to conversation recording unit 103. These control signals include start and stop signals to start and stop recording the conversation, start and stop playback of the recorded conversation, and start and stop memo recording. A “start-memo-recording” signal records, during the conversation, only the speech of the party whose telephone transmitted the start-memo-recording signal. That is, when a start, or stop, memo recording signal is given, the duplex conversation continues without change, and with only the initiating party's side of the conversation being effected by the “memo” procedure. Telephone users can initiate the control signals by, for example, depressing a predetermined button or button sequence on the telephone or by speaking one or more predetermined words.

Processor 155 processes a “start-recording” signal by instructing a conversation storage unit 150 to start recording the conversation. Processor 155 identifies the party who initiated the recording (the identity of the recording party is found from infrastructure unit 101 as described below; in this description, a recording party refers to one or more recording parties and a non-recording party refers to one or more non-recording parties). When it receives a “stop-recording” signal from one of the parties, processor 155 instructs conversation storage unit 150 to stop recording the conversation. Playback of the recorded conversation occurs, for example, when the recording party (as previously identified by processor 155) requests playback of the recorded conversation by sending a “playback” signal to processor 155. Here, processor 155 checks if the requesting party (i.e., the party requesting playback of the recorded conversation; in this description, the requesting party refers to one or more requesting parties and the non-requesting party refers to one or more non-requesting parties) is authorized for playback service. If the requesting party is authorized for playback service, then processor 155 accesses conversation storage unit 150 and plays back the appropriate conversation to the requesting party. The appropriate conversation (the recorded conversation played back to the requesting party), may be, for example, the most recently recorded conversation or all the recorded conversations stored on conversation storage unit 150.

Conversation recording unit 103 also includes conversation storage unit 150 that is coupled to processor 155. Conversation storage unit 150 stores conversations via random access memory, hard disk drive, optical drive (e.g., a compact disc-recordable drive), tape drive, or other digital or analog storage technologies. Conversation recording unit 103 also includes a location status database 170, coupled to processor 155, that before the conversation is recorded, processor 155 references location status database 170 to determine if the applicable law at the location of the non-recording party mandates that the non-recording party be notified that the conversation is being recorded. If the applicable law at the location of the non-recording party mandates that the non-recording party be notified, then a notification unit 175, coupled to processor 155, is used to inform the non-recording party that the conversation is being recorded. The notification could occur by using an intermittent background tone (heard by the non-recording party), as currently employed by radio stations, or by indication on the visual annunciator panel on the subscriber set. If the applicable law at the location of the non-recording party does not mandate that the non-recording party be notified, then depending on a preference, the non-recording party may not receive any notification prior to recording the conversation. Alternatively, upon one of the parties requesting that the conversation be recorded, the non-recording party is automatically notified that the conversation is being recorded without reference to location status database 170.

If the telephone conversation is transmitted over conventional telephone lines in analog form, then processor 155 is also coupled to an analog to digital converter (A/D) 160 and a digital to analog converter (D/A) 165. A/D 160 converts analog signals to digital signals so that processor 155 can, for example, analyze the control signals (e.g., start/stop recording the conversation) and be able to store the conversation. D/A 165 converts the digital signals back to analog signals for transmitting the conversation over conventional telephone lines.

After the non-recording party is notified that the conversation is being recorded, the non-recording party can object to this recording and stop the recording by initiating a stop-recording signal. The signal can be a predetermined button or button sequence, or by speaking one or more predetermined words.

Conversation recording unit 103 provides a memo recording feature that, during the conversation, records the speech of only the party who initiated the memo recording feature (e.g., the memo recording feature could be initiated by transmitting the start-memo-recording signal). This feature can be used, for example, when one of the parties objects to the recording of the conversation. In this case, the party initiating the memo recording feature can repeat the words of the objecting party (as if to verify the information provided by the objecting party) in order to indirectly record the information provided by the objecting party.

Conversation recording unit 103, upon receiving an “always-record” signal, thereafter, automatically records all telephone conversations. After receiving the always-record signal, before recording the current conversation or any future conversations, conversation recording unit 103 notifies the non-recording party to the conversation that the conversation is being recorded if the applicable law at the location of the non-recording party mandates that the non-recording party be notified when the conversation is being recorded. Alternatively, after receiving the always-record signal, before recording any conversations, the non-recording party is automatically notified that the conversation is being recorded without reference to location status database 170.

Conversation recording unit 103, upon receiving a “never-can-record” signal as a condition of service, does not allow recording of that conversation. Alternatively, the conversation can be recorded if the telephone sending the never-can-record signal is located where the applicable law does not mandate that this party be notified when the conversation is being recorded. In this case, the never-can-record signal only blocks recording in locations that proscribe recording without notification.

In an alternative embodiment, conversation recording unit 103 also includes a speech recognition unit that is coupled to processor 155 and conversation storage unit 150. The speech recognition unit can be used for, among other functions, to send the recorded conversation to a recording party as text data via e-mail. The speech recognition unit analyzes the digitized voice signals stored in conversation storage unit 150 and converts those voice signals to text data. The speech recognition unit includes the functionalities found in commercially available programs such as ViaVoice by International Business Machines or Naturally Speaking by Dragon Systems. Either automatically at the end of the conversation (e.g., conversation recording unit 103 is configured to automatically send all recorded conversations to the requesting user as an e-mail) or upon receiving a predetermined “e-mail playback” signal from a requesting party, processor 155 instructs the speech recognition unit to convert the digitized voice signals to text data. Processor 155 then formats the text data for e-mail (e.g., creates an envelope for the text data which in addition to the text data may include a destination address, priority, and security level). Processor 155 then establishes a connection to the appropriate server in order to transmit the recorded conversation as an e-mail to the requesting party.

Alternatively, conversation recording unit 103, either automatically at the end of the conversation (e.g., conversation recording unit 103 is configured to automatically transform the recorded conversations to a Web page and post that Web page on a server) or upon receiving a predetermined “Web-post” signal, formats the text data as a Web page and transmits that Web page to the server so that a user can access it, for example, using a Web browser such as Internet Explorer from Microsoft Corporation. The Web browser allows the user to view the Web page. Conversation recording unit 103 formats the text data as a Web page by, for example, enclosing the text data in a markup language such as Hypertext Markup Language (“HTML”). HTML uses tags to mark elements, such as the text data, in the Web page to indicate how the Web browser should display that element to the user.

Infrastructure unit 101 identifies which of the several mobile telephones 105 or fixed telephone 106 initiated recording the conversation (e.g., this identification is used for the playback service described above). The identity of the party initiating the recording is available in the infrastructure unit 101 and is currently used to determine which party initiated the original call for billing purposes. For example, number button depressions on the initiating telephone unit (mobile telephone 105 or fixed telephone 106) can be detected by infrastructure unit 101 as different from those of the called telephone unit even if they are the same number buttons producing the same “DTMF” audio frequencies. This detection is used so that the party requesting that the conversation be recorded has access to the recorded conversation and also is billed for that service.

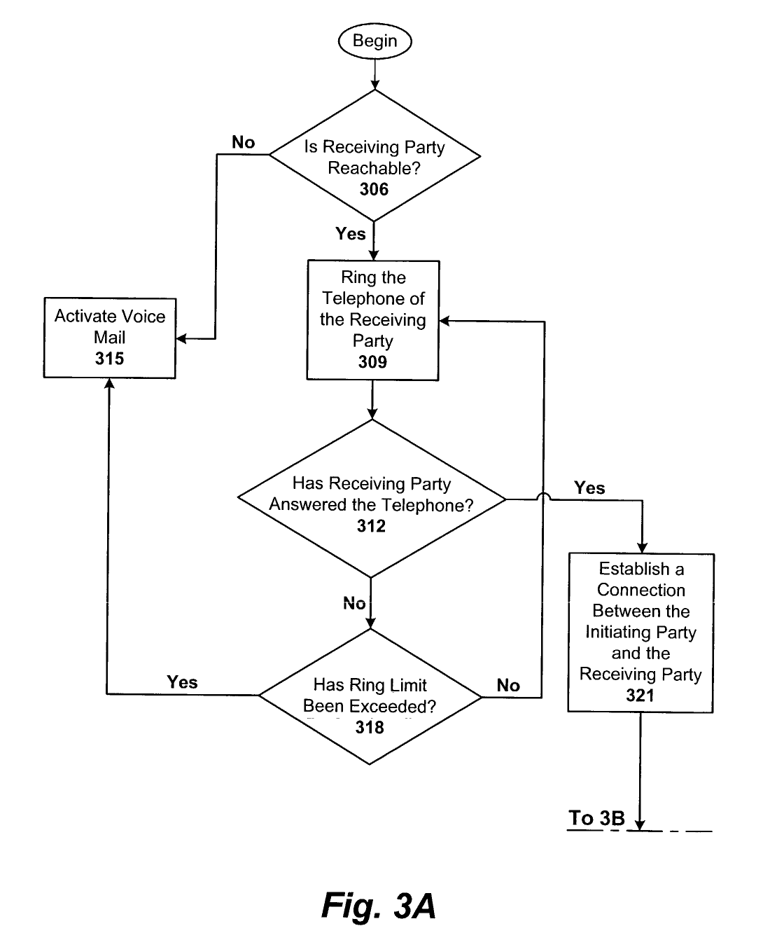

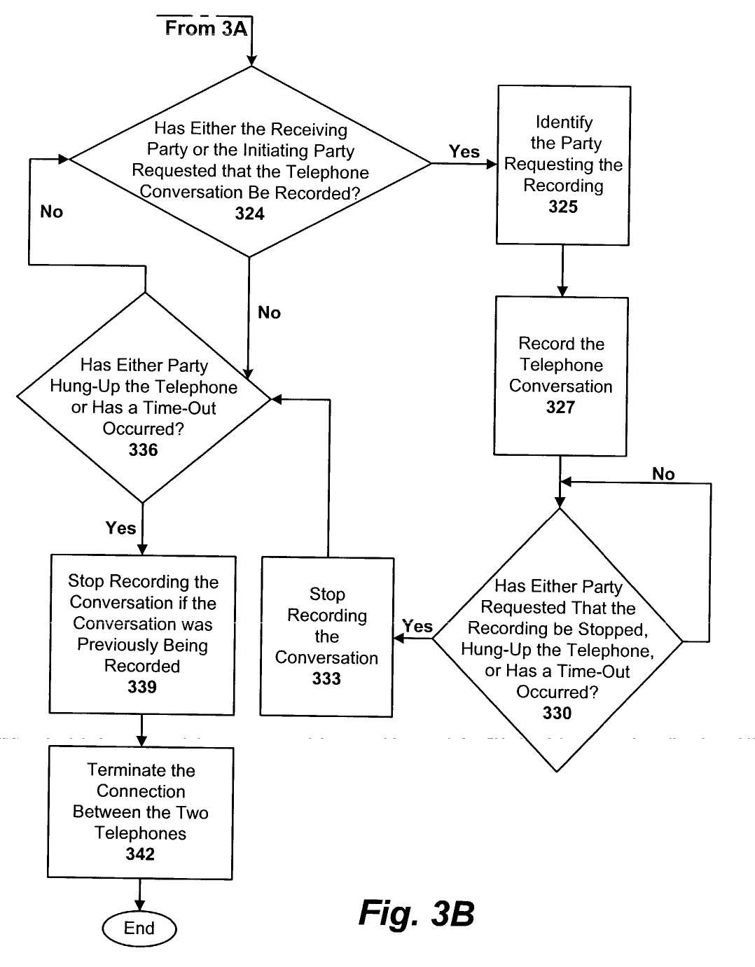

FIG. 3 shows a flowchart describing a process for recording a telephone conversation during an ongoing conversation according to one embodiment of the present invention. In step 306, infrastructure unit 101 determines if a receiving party (for purposes of this description, assume that there are two parties to the telephone conversation—an initiating party and a receiving party) is reachable. If the receiving party is not reachable (e.g., the receiving party may not be reachable if the line is busy or mobile telephone 105 is out of cellular coverage), then in step 315, the receiving party's voice mail is activated allowing the initiating party to leave a message for the receiving party. If the receiving party is reachable, then in step 309, the receiving party's telephone is rung. In step 312, infrastructure unit 101 determines if the receiving party has answered the telephone. If the receiving party has not answered the telephone, then in step 318, infrastructure unit 101 determines if the ring limit has been exceeded. If the ring limit has been exceeded, then in step 315, the voice mail is activated allowing the initiating party to leave a message for the receiving party. If the ring limit has not been exceeded, then in step 309, the receiving party's telephone is rung again. If the receiving party does answer the telephone, then in step 321, infrastructure unit 101 establishes a connection between the initiating party and the receiving party.

In step 324, it is determined if either of the parties to the telephone conversation requested that the telephone conversation be recorded (e.g., requested that the conversation be recorded by sending the start-recording signal). If one of the parties requested that the telephone conversation be recorded, then in step 325, the party requesting the recording is identified. The identity of the recording party (i.e., the party requesting that the conversation be recorded) is obtained from, for example, infrastructure unit 101 which can identify the party that, e.g., depresses the predetermined button or button sequence used to specify the request to record the conversation. In step 327, the telephone conversation is recorded by storing it in conversation storage unit 150. Before recording the conversation, location status database 170 is referenced to determine if the applicable law at the location of the non-recording party mandates that the non-recording party be notified. The non-recording party is notified if the applicable law mandates such action.

In step 330, it is determined if any of the parties requested that the conversation recording be stopped (e.g., by sending the stop-recording signal), if one of the parties hung-up the telephone, if a disconnect occurred (e.g., the physical connection between the parties was broken), or if a time-out occurred (e.g., there was no activity on the telephone lines between the parties for a predetermined time period). If none of these events occur, then the recording of the conversation continues until one of these events occur. If one of those events does occur, then in step 333, the recording of the conversation is stopped. Then, in step 336, it is determined if either party hung-up the telephone or a disconnect occurred. If either of these two events does not occur, then in step 324, it is determined if either party requested that the conversation be recorded. During the conversation, the parties may start or stop recording the conversation as many times as desired. If either party hung-up the telephone or a disconnect occurred, then in step 339, the recording of the conversation is stopped if the conversation was previously being recorded. In step 342, infrastructure unit 101 terminates the connection between the telephones of the initiating party and the receiving party.

Depending on the desired features, in other embodiments of the present invention, after the non-recording party is notified that the conversation is being recorded, the non-recording party may object to this recording and stop the recording by initiating the stop-recording signal. In addition, if the applicable law at the location of the non-recording party mandates that the non-recording party be notified, then prior to recording the conversation, the non-recording party is notified that the conversation is going to be recorded. The notification could occur by using an intermittent background tone (heard by the non-recording party). If the applicable law at the location of the non-recording party does not mandate that the non-recording party be notified, then depending on a preference, the non-recording party may not receive any notification prior to recording the conversation. Embodiments of the present invention monitor the location of one or more of the parties to the conversation on an ongoing basis, either continuously, at periodic intervals, or in response to an event such as a change in cell locations, as a means for ensuring compliance with the applicable law at the party's location.

If one of the parties objects to recording the conversation, then the memo recording feature may be initiated. With the memo recording feature, the party initiating that feature repeats the words of the objecting party (as if to verify the information provided by the objecting party) in order to indirectly record the information provided by the objecting party.

The telephone of one of the parties may transmit the always-record signal that directs that all conversations be recorded. After receiving the always-record signal, before recording any conversation, the non-recording party is notified that the conversation is being recorded if the applicable law at the location of the non-recording party mandates that the non-recording party be notified when the conversation is being recorded.

The telephone of one of the parties may also transmit the never-can-record signal to prohibit recording the conversation. Alternatively, the conversation can be recorded if the telephone sending the never-can-record signal is located where the applicable law does not mandate that this party be notified when the conversation is being recorded. In this case, the never-can-record signal only blocks recording in locations that proscribe recording without notification.

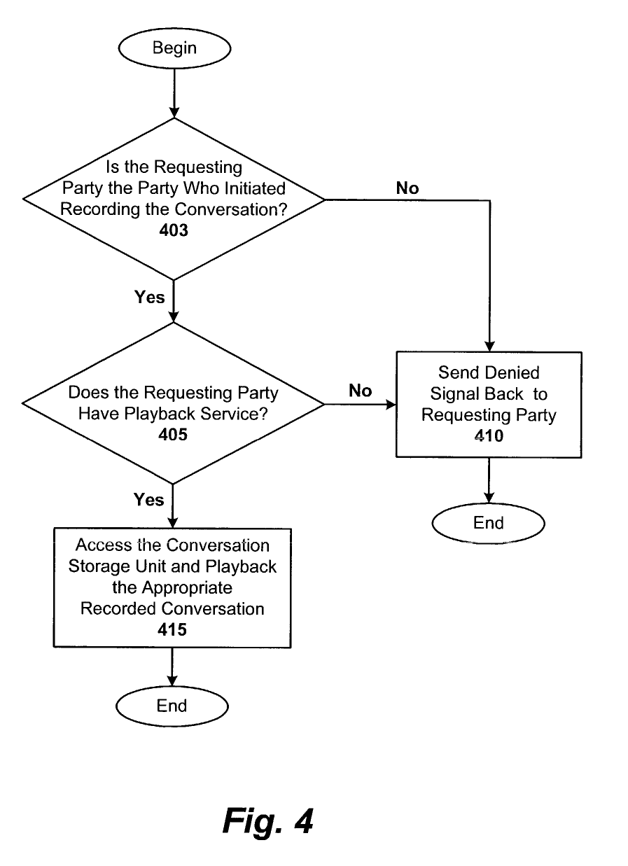

FIG. 4 shows a flowchart describing a process for playing back a recorded telephone conversation according to a first embodiment of the present invention. In step 403 it is determined if the requesting party (i.e., the party requesting that a recorded conversation be retrieved by initiating a playback signal) is the party who initiated recording the conversation. The identity of the party who initiated recording the conversation is available from, for example, infrastructure unit 101 which uses this information for billing purposes. The identity of the party who initiated recording the conversation is stored with the recorded conversation. If the requesting party is not the party who initiated recording the conversation, then in step 410, a denied signal is sent to the telephone of the requesting party. If the requesting party is the party who initiated recording the conversation, then in step 405, it is determined if the requesting party has playback service (e.g., playback service is an account similar to a voice mail account where a party enters a personal identification number (“PIN”) in order to access his or her recorded conversations). If the requesting party does not have playback service, then in step 410, a denied signal is sent to the telephone of the requesting party. If the requesting party does have playback service, then in step 415, conversation storage unit 150 is accessed and the appropriate recorded conversation is played back to the requesting party. The appropriate recorded conversation can be, for example, the most recently recorded conversation or all the recorded conversations stored in conversation storage unit 150 that the requesting party initiated recording.

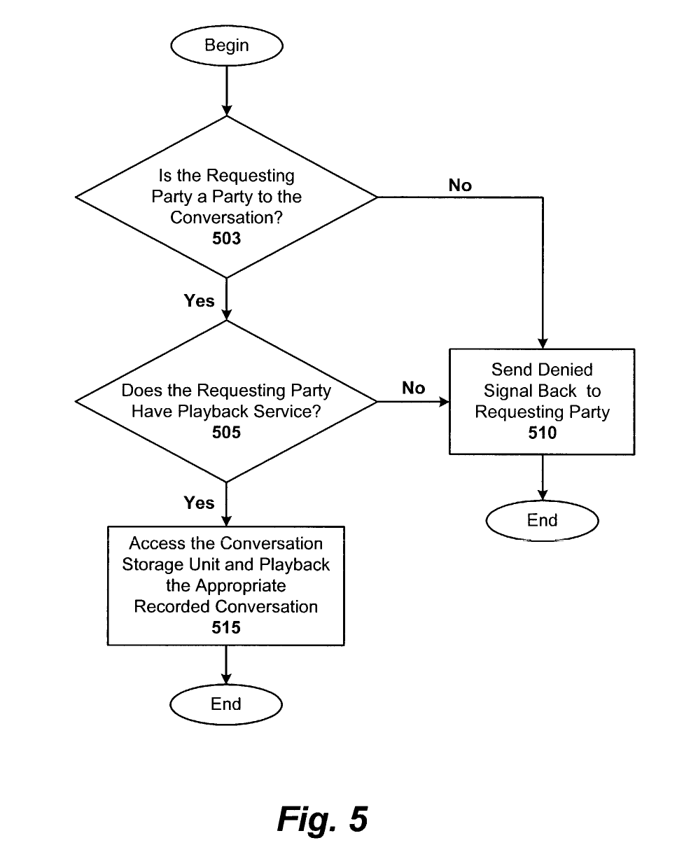

FIG. 5 shows a flowchart describing a process for playing back a recorded telephone conversation according to a second embodiment of the present invention. In this embodiment, rather than allowing playback of the recorded conversation only to the party who initiated recording the conversation, all parties to the conversation may playback the recorded conversation. In step 503, it is determined if the requesting party (i.e., the party requesting that a recorded conversation be retrieved by initiating the playback signal) is a party to the recorded conversation. The identities of the parties to the conversation are available from, for example, the infrastructure unit 101 which uses this information for billing purposes. The identities of the parties to the conversation are stored with the recorded conversation. If the requesting party is not a party to the recorded conversation, then in step 510, a denied signal is sent to the telephone of the requesting party. If the requesting party is a party to the recorded conversation, then in step 505, it is determined if the requesting party has playback service. If the requesting party does not have playback service, then in step 510, a denied signal is sent to the telephone of the requesting party. If the requesting party does have playback service, then in step 515, conversation storage unit 150 is accessed and the appropriate recorded conversation is played back to the requesting party.

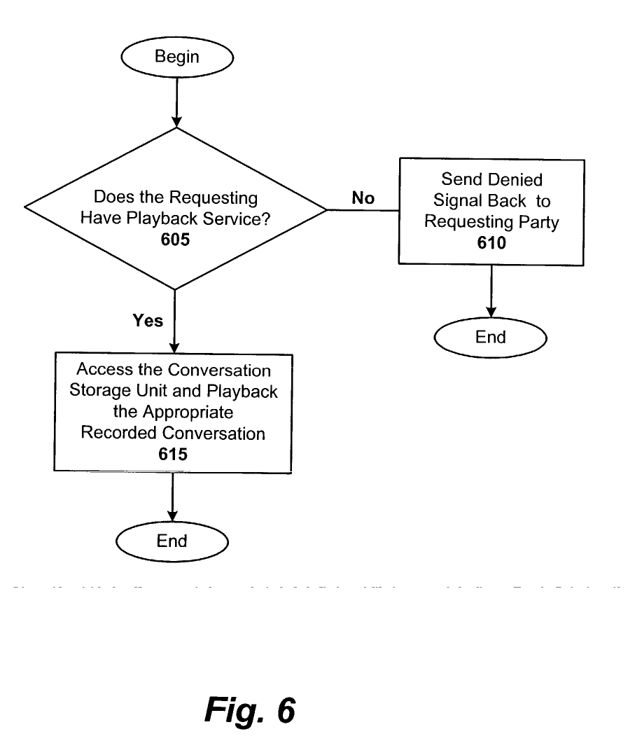

FIG. 6 shows a flowchart describing a process for playing back a recorded telephone conversation according to a third embodiment of the present invention. Here, rather than allowing playback of the recorded conversation only to the parties to the conversation, anyone with playback service can playback the recorded conversation (step 403 in FIG. 4 is omitted). In step 605, it is determined if the requesting party has playback service. If the requesting party does not have playback service, then in step 610, a denied signal is sent to the telephone of the requesting party. If the requesting party does have playback service, then in step 615, conversation storage unit 150 is accessed and the appropriate recorded conversation is played back to the requesting party.

Alternatively, rather than allowing anyone to playback the recorded conversation, the parties to the conversation designate the telephones that can playback the recorded conversation. The identities of these telephones that are allowed to playback the recorded conversation are stored in conversation storage unit 150 along with the recorded conversation.

As an alternative to audio playback of the recorded conversation to the requesting party, after, for example, verifying that the requesting party does have playback service, the recorded conversation is converted to text data and sent to a requesting party via e-mail. In this case, either automatically at the end of the conversation or upon receiving the predetermined e-mail playback signal from the requesting party, the stored digitized voice signals are converted to text data. The text data is then formatted for e-mail (e.g., creates an envelope for the text data which in addition to the text data may include a destination address, priority, and security level). A connection is established to the appropriate server in order to transmit the recorded conversation as an e-mail to the appropriate party.

As another alternative to audio playback of the recorded conversation to the requesting party, either automatically at the end of the conversation or upon receiving the predetermined Web-post signal from the requesting party, the recorded conversation is converted to text data and formatted as a Web page and transmitted to a server so that the user can access it, for example, using the Web browser. The text data is formatted as a Web page by, for example, enclosing the text data in a markup language such as HTML.

In yet another embodiment, the present invention allows the recorded conversation to be sent as an audio file, thus omitting the need to convert the voice signals to text data. The audio file could be sent as an e-mail attachment, in any of a number of formats, or a pointer to the audio file could be posted to a web page.

If the non-recording party (i.e., the party not requesting that the conversation be recorded) moves his or her telephone from a location whose applicable law does not mandate that the non-recording party be notified when the conversation is being recorded to a location that does (the applicable law at a specific location is determined by, for example, referencing location status database 170), then the non-recording party is notified that the conversation is being recorded. Upon notification, as described earlier, the non-recording party may stop the recording at which point the recording party may initiate the memo recording feature. Alternatively, only the recording party is notified that the non-recording party has moved to a location whose applicable law mandates that the non-recording party be notified that the conversation is being recorded and upon notification, the conversation recording is automatically stopped or the memo recording feature is initiated. Other of the present invention may send some indication, such as a “beep,” to the requesting party when the non-requesting party's conversation is no longer being recorded, which would allow that party to mimic the dialog of the other party or otherwise take notes of the conversation.

Each of the conversations stored in conversation storage unit 150 includes a header. The header may include the identity of the telephone of the recording party (i.e., the party that initiated recording the conversation), the identity of the telephone of the non-recording party, and for each of these parties, their telephone numbers and locations during the conversation. The header may also include the date of the conversation, the start time and the end time of the conversation, and the type of notification, if any, provided to the non-recording party. Also, the header may include the identities of the parties allowed to playback this conversation, and the identities of the users that are allowed to alter the parties that can playback this conversation and a unique serial number. The unique serial number can be derived from data such as, but not limited to, the combination of the phone number of the non-recording party, and the date, the start time and the end time of the conversation. Embodiments of the present invention allow users to edit the header, such as to add information for indexing, cross-referencing, and/or retrieval by keyword.

Although embodiments are specifically illustrated and described herein, it will be appreciated that modifications and variations of the present invention are covered by the above teachings and within the purview of the appended claims without departing from the spirit and intended scope of the invention.

What is claimed is:

1. A telephone system for recording a conversation, or signals, comprising:
a conversation recording unit that records the conversation among a first party on a first telephone and a second party on a second telephone; and
an infrastructure unit that interconnects the first telephone and the second telephone,
wherein the first telephone and the second telephone are a fixed telephone or a mobile telephone and the conversation recording unit is located within at least one of the infrastructure unit, the first telephone and the second telephone that is the mobile telephone, and an outside facility that is conferenced in to record the conversation.

2. The telephone system of claim 1, wherein the conversation recording unit begins recording the conversation upon receiving a start-recording signal.

3. The telephone system of claim 2, wherein the conversation recording unit upon receiving the start-recording signal from the first telephone or the second telephone notifies the other telephone that the conversation is being recorded.

4. The telephone system of claim 2, wherein the conversation recording unit upon receiving the start-recording signal from the first telephone or the second telephone notifies the other telephone that the conversation is being recorded if reference to a location status database finds that laws of a location of the other telephone mandates that the party on the other telephone be notified that the conversation is being recorded.

5. The telephone system of claim 4, wherein said location is updated on an ongoing basis.

6. The telephone system of claim 1, wherein the conversation recording unit upon receiving an always-record signal from the first telephone or the second telephone, thereafter, automatically notifies the other telephone that the conversation is being recorded whenever the telephone sending the always-record signal is involved in the conversation.

7. The telephone system of claim 1, wherein the conversation recording unit upon receiving an always-record signal from the first telephone or the second telephone, thereafter, automatically notifies the other telephone that the conversation is being recorded whenever the telephone that sends the always-record signal is involved in the conversation, and reference to a location status database finds that laws of a location of the other telephone mandates that the party on the other telephone be notified that the conversation is being recorded.

8. The telephone system of claim 1, wherein the conversation recording unit upon receiving a start-memo-recording signal from the first telephone or the second telephone records speech only of the party on the telephone that sent the start-memo-recording signal.

9. The telephone system of claim 1, wherein the conversation recording unit terminates recording the conversation upon receiving a stop-recording signal, the first party hanging-up the first telephone, the second party hanging-up the second telephone, physically disconnecting telephone lines that connect the first telephone and the second telephone, or a time-out occurring because the telephone lines connecting the first telephone and the second telephone are inactive for a predetermined period.

10. The telephone system of claim 9, wherein the conversation recording unit allows the first telephone or the second telephone to resume recording the conversation after recording of the conversation is terminated by the conversation recording unit receiving a stop-recording signal, or a time-out occurs because the telephone lines connecting the first telephone and the second telephone are inactive for a predetermined period.

11. The telephone system of claim 1, wherein the conversation recording unit plays back the recorded conversation if a playback signal is received and a requesting party has access to the recorded conversation.

12. The telephone system of claim 1, wherein the conversation recording unit plays back the recorded conversation if a playback signal is received and a requesting party that is the first party or the second party has access to the recorded conversation and the requesting party initiated recording the conversation.

13. The telephone system of claim 1, wherein the conversation recording unit plays back the recorded conversation if a playback signal is received and a requesting party that is the first party or the second party has access to the recorded conversation.

14. The telephone system of claim 1, wherein the conversation recording unit converts the recorded conversation from voice signals to text data.

15. The telephone system of claim 14, wherein the conversation recording unit formats the text data as an e-mail message by encapsulating the text data in an envelope and transmits the envelope to a server.

16. The telephone system of claim 14, wherein the conversation recording unit formats the text data as a Web page using a markup language and transmits the Web page to a server.

17. The telephone system of claim 14, wherein said recorded conversation is stored as an audio file.

18. The telephone system of claim 1, wherein the conversation recording unit does not record the conversation if the first telephone or the second telephone sends a never-can-record signal.

19. The telephone system of claim 2, wherein the conversation recording unit records the conversation upon receiving the start-recording signal if the first telephone or the second telephone sends a never-can-record signal and the telephone that sends the never-can-record signal is at a location whose laws do not mandate that the telephone sending the never-can-record signal be notified that the conversation is being recorded.

20. A conversation recording unit, comprising:
a conversation storage unit that stores a conversation among a first party on a first telephone and a second party on a second telephone; and
a processor, coupled to the conversation storage unit, that directs the conversation to the conversation storage unit for storage upon receiving a control signal to record the conversation.

21. The conversation recording unit of claim 20, wherein an analog to digital converter, coupled to the processor, converts the conversation and the control signal from analog form to digital form and sends the conversation and the control signal to the processor for analysis.

22. The conversation recording unit of claim 20, wherein a digital to analog converter, coupled to the processor, converts the conversation from digital form to analog form.

23. The conversation recording unit of claim 20, wherein the processor directs the conversation to the conversation storage unit upon receiving a start-recording signal.

24. The conversation recording unit of claim 20, further comprising a location status database, coupled to the processor, that specifies whether laws at a location of the first telephone or the second telephone mandate that the party on the telephone be notified that the conversation is being recorded.

25. The conversation recording unit of claim 24, wherein said location status data base is checked on an ongoing basis.

26. The conversation recording unit of claim 20, further comprising a notification unit, coupled to the processor, that upon the processor receiving a start-recording signal from the first telephone or the second telephone notifies the other telephone that the conversation is being recorded.

27. The conversation recording unit of claim 24, further comprising a notification unit, coupled to the processor, that upon receiving a start-recording signal from the first telephone or the second telephone notifies the other telephone that the conversation is being recorded if reference to the location status database finds that laws of a location of the other telephone mandates that the party on the other telephone be notified that the conversation is being recorded.

28. The conversation recording unit of claim 20, further comprising a notification unit, coupled to the processor, that upon the processor receiving an always-record signal from the first telephone or the second telephone, thereafter, automatically notifies the other telephone that the conversation is being recorded whenever that telephone sending the always-record signal is involved in the conversation.

29. The conversation recording unit of claim 24, further comprising a notification unit, coupled to the processor, that upon the processor receiving an always-record signal from the first telephone or the second telephone, thereafter, automatically notifies the other telephone that did not send the always-record signal that the conversation is being recorded whenever the telephone sending the always-record signal is involved in the conversation and reference to the location status database finds that laws of a location of the other telephone mandates that the party on the other telephone be notified that the conversation is being recorded.

30. The conversation recording unit of claim 20, wherein the processor, upon receiving a start-memo-recording signal from the first telephone or the second telephone, records speech only of the party on the telephone that sent the start-memo-recording signal.

31. The conversation recording unit of claim 20, wherein the processor terminates directing the conversation to the conversation storage unit upon receiving a stop-recording signal, the first party hanging-up the first telephone, the second party hanging-up the second telephone, physically disconnecting telephone lines that connect the first telephone and the second telephone, or a time-out occurring because the telephone lines connecting the first telephone and the second telephone are inactive for a predetermined period.

32. The conversation recording unit of claim 31, wherein the processor resumes recording the conversation upon receiving the start-recording signal from the first telephone or the second telephone after recording of the conversation is terminated by the conversation recording unit receiving a stop-recording signal, or a time-out occurs because the telephone lines connecting the first telephone and the second telephone are inactive for a predetermined period.

33. The conversation recording unit of claim 20, wherein the processor accesses the conversation storage unit and plays back the stored conversation if a playback signal is received and a requesting party that is the first party or the second party has access to the recorded conversation.

34. The conversation recording unit of claim 20, wherein the processor accesses the conversation storage unit and plays back the stored conversation if a playback signal is received and a requesting party that is the first party or the second party has access to the recorded conversation and the requesting party initiated recording the conversation.

35. The conversation recording unit of claim 20, further comprising a speech recognition unit, coupled to the processor and the conversation storage unit, that converts the stored conversation in the conversation storage unit from voice signals to text data.

36. The conversation recording unit of claim 35, wherein the processor formats the text data as an e-mail message by encapsulating the text data in an envelope and transmits the envelope to a server.

37. The conversation recording unit of claim 35, wherein the processor formats the text data as a Web page using a markup language and transmits the Web page to a server.

38. The conversation recording unit of claim 20, wherein said stored conversation is in an audio file format.

39. A method for recording a conversation, comprising:
establishing a connection among a first telephone and a second telephone; and
recording the conversation among a first party on the first telephone and a second party on the second telephone,
wherein the first telephone and the second telephone are a fixed telephone or a mobile telephone and the recording occurs within at least one of an infrastructure unit, the first telephone and the second telephone that is the mobile telephone, and an outside facility that is conferenced in to record the conversation.

40. The method of claim 39, wherein recording the conversation begins upon receiving a start-recording signal.

41. The method of claim 40, further comprising, upon receiving the start-recording signal from the first telephone or the second telephone, notifying the other telephone that the conversation is being recorded.

42. The method of claim 40, further comprising, upon receiving the start-recording signal from the first telephone or the second telephone, notifying the other telephone that the conversation is being recorded if reference to a location status database finds that laws of a location of the other telephone mandates that the party on the other telephone be notified that the conversation is being recorded.

43. The method of claim 39, further comprising, upon receiving an always-record signal from the first telephone or the second telephone, thereafter, automatically notifying the other telephone that the conversation is being recorded whenever the telephone sending the always-record signal is involved in the conversation.

44. The method of claim 39, further comprising, upon receiving an always-record signal from the first telephone or the second telephone, thereafter, automatically notifying the other telephone that did not send the always-record signal that the conversation is being recorded whenever the telephone sending the always-record signal is involved in the conversation and reference to the location status database finds that laws of a location of the other telephone mandates that the party on the other telephone be notified that the conversation is being recorded.

45. The method of claim 39, further comprising, upon receiving a start-memo-recording signal from the first telephone or the second telephone, recording speech only of the party on the telephone that sent the start-memo-recording signal.

46. The method of claim 39, further comprising terminating the recording of the conversation upon receiving a stop-recording signal, the first party hanging-up the first telephone, the second party hanging-up the second telephone, physically disconnecting telephone lines that connect the first telephone and the second telephone, or a time-out occurring because the telephone lines connecting the first telephone and the second telephone are inactive for a predetermined period.

47. The method of claim 46, further comprising resuming recording the conversation after recording of the conversation is terminated by the conversation recording unit receiving a stop-recording signal, or a time-out occurs because the telephone lines connecting the first telephone and the second telephone are inactive for a predetermined period.

48. The method of claim 39, further comprising playing back the recorded conversation if a playback signal is received and a requesting party that is the first party or the second party has access to the recorded conversation.

49. The method of claim 39, further comprising playing back the recorded conversation if a playback signal is received and a requesting party that is the first party or the second party has access to the recorded conversation and the requesting party initiated recording the conversation.

50. The method of claim 39, further comprising converting the recorded conversation from voice signals to text data.

51. The method of claim 50, further comprising formatting the text data as an e-mail message by encapsulating the text data in an envelope and then transmitting the envelope to a server.

52. The method of claim 50, further comprising formatting the text data as a Web page using a markup language and then transmitting the Web page to a server.

53. The method of claim 39, wherein said conversation is stored as an audio file.

54. The method of claim 39, wherein recording the conversation does not occur if the first telephone or the second telephone sends a never-can-record signal.

55. The method of claim 40, wherein recording the conversation occurs upon receiving the start-recording signal if the first telephone or the second telephone sends a never-can-record signal and the telephone that sends the never-can-record signal is at a location whose laws do not mandate that the telephone sending the never-can-record signal be notified that the conversation is being recorded.

56. A header of a recorded conversation, comprising:
a unique serial number, and
identities of
a first telephone of a first party that initiated recording a conversation;
a second telephone of a second party that did not initiate recording the conversation; and
parties that are allowed to playback the recorded conversation.

57. The header of claim 56, further comprising:
telephone numbers of the first telephone and the second telephone;
locations of the first telephone and the second telephone;
date of the conversation;
start time of the conversation;
end time of the conversation;
type of notification provided to the second party on the second telephone; and
identities of users allowed to alter the parties that can playback the recorded conversation.

58. The header of claim 56, wherein a set of user defined header information may be appended to the header.
